(19) United States
(12) Patent Application Publication
(10) Pub. No.: US 2016/0275023 A1
(43) Pub. Date: Sep. 22, 2016

(54) INFORMATION PROCESSING APPARATUS AND RECORDING MEDIUM

(71) Applicant: TOSHIBA TEC KABUSHIKI KAISHA, Tokyo (JP)

(72) Inventor: Tsutomu Kawamoto, Shizuoka (JP)

(21) Appl. No.: 14/662,425

(22) Filed: Mar. 19, 2015

(51) Int. Cl. G06F 13/24; G06F 9/445; G06Q 20/20

(52) U.S. Cl. CPC G06F 13/24; G06Q 20/209; G06F 9/44505

(57) ABSTRACT

In accordance with one embodiment, an information processing apparatus comprises an operation section, a signal generation section and a control section. The operation section outputs an operation signal indicating that it is operated by a user. The signal generation section generates a first control signal and a second control signal based on the operation signal from the operation section. The control section starts a pre-determined program based on the first control signal and executes an interruption processing of the pre-determined program based on the second control signal. The interruption processing means temporarily stopping the pre-determined program being executed or releasing the temporary stop of the pre-determined program.

### FIELD

Embodiments described herein relate generally to an information processing apparatus and a recording medium.

### BACKGROUND

Conventionally, an information processing apparatus temporarily stops the processing of programs being executed through a key input of an operation key of a connected keyboard. However, in a case in which no keyboard is connected, or in a case in which the keyboard is out of order, the information processing apparatus cannot temporarily stop the processing of the started programs.

### BRIEF DESCRIPTION OF THE DRAWINGS

FIG. 1 is a diagram illustrating an example of the constitution of an information processing apparatus 1 according to a first embodiment;

FIG. 2 is a block diagram illustrating an example of the constitution of a signal generation section 3 according to the first embodiment;

FIG. 3 is a flowchart illustrating the operation of a control section 4 in a case in which an operation section 2 is operated “ON” according to the first embodiment;

FIG. 4 is a flowchart illustrating the operation of an interruption processing of the control section 4 according to the first embodiment; and

FIG. 5 is a diagram illustrating an example of the constitution of an information processing apparatus 1a according to a second embodiment.

### DETAILED DESCRIPTION

In accordance with one embodiment, an information processing apparatus comprises an operation section, a signal generation section and a control section. The operation section outputs an operation signal indicating that it is operated by a user. The signal generation section generates a first control signal and a second control signal based on the operation signal from the operation section. The control section starts a pre-determined program based on the first control signal and executes an interruption processing of the program based on the second control signal. The interruption processing means temporarily stopping the program being executed or releasing the temporary stop of the program.

### A First Embodiment

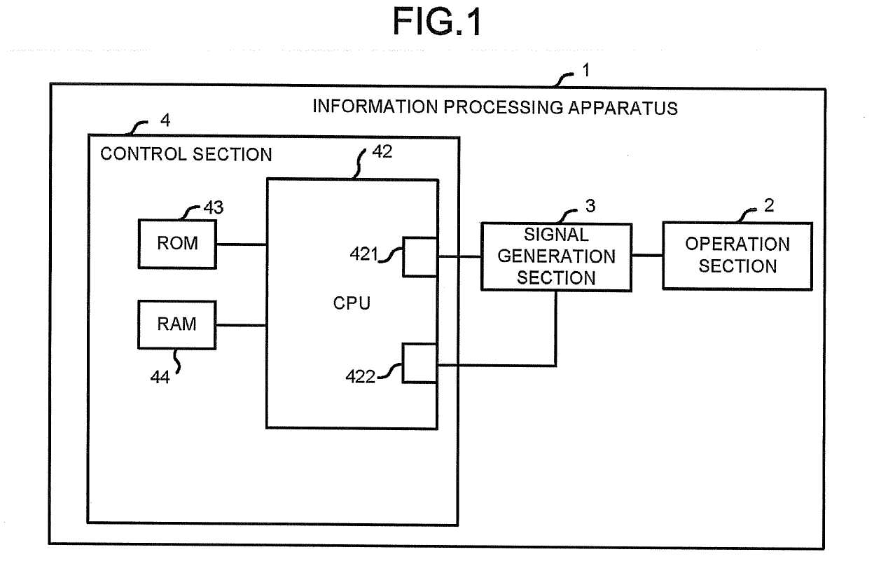

Hereinafter, the information processing apparatus according to the first embodiment is described in detail with reference to the accompanying drawings. FIG. 1 is a diagram illustrating an example of the constitution of an information processing apparatus 1 according to the first embodiment.

For example, the information processing apparatus 1 is a POS (Point Of Sale) terminal apparatus. The information processing apparatus 1 includes an operation section 2, a signal generation section 3 and a control section 4.

The operation section 2, if operated “ON” by a user, outputs an operation signal indicating the “ON” operation to the control section 4. The “ON” operation refers to a user operation for turning on the power source of the information processing apparatus 1. For example, the operation section 2 is a soft switch for turning on or turning off the power source of the information processing apparatus 1.

The signal generation section 3 generates a first control signal and a second control signal based on the operation signal from the operation section 2. The signal generation section 3, if acquiring the operation signal, generates the first control signal and the second control signal of a first level. The signal generation section 3, if acquiring no operation signal, generates the first control signal and the second control signal of a second level.

The signal generation section 3 outputs the generated first control signal or second control signal to the control section 4. Incidentally, the first level is a high level, and the second level is a low level.

The control section 4 executes start program based on the first control signal supplied from the signal generation section 3. The control section 4 includes a CPU 42, a ROM 43 and a RAM 44.

The CPU 42 controls the whole operations of the information processing apparatus 1. The CPU 42 includes a first input section 421 and a second input section 422. The first input section 421 is connected with the signal generation section 3. For example, the first input section 421 is a dedicated interface for detecting the “ON” operation of the operation section 2. The first control signal generated by the signal generation section 3 is supplied to the first input section 421.

The second input section 422 is connected with the signal generation section 3. The second input section 422 is a general purpose input/output (GPIO) interface the functions of which can be defined by BIOS. In the present embodiment, the second input section 422 is defined as an input interface. The second control signal generated by the signal generation section 3 is supplied to the second input section 422.

The CPU 42 executes start processing of a pre-determined program if the first input section 421 detects the first control signal of the second level. That is, the CPU 42 reads the pre-determined program stored in the ROM 43 and copies or decompresses the pre-determined program on the RAM 44. The CPU 42 controls the operation of each section of the information processing apparatus 1 according to the program. For example, the pre-determined program is BIOS (Basic Input Output System). The BIOS is a program in which a routine for controlling the hardware in the system is organized.

The ROM 43 stores the BIOS and various control data. The BIOS operates when the power source of the information processing apparatus 1 is turned on. The BIOS copies or decompresses an operating system stored in a hard disk drive on the RAM 44. Then the BIOS starts the operating system.

If the second input section 422 detects the second control signal of the second level when the pre-determined program is started, the CPU 42 executes an interruption processing. The interruption processing means temporarily stopping the program in operation or releasing the temporary stop of the program that is in temporary stop. For example, the CPU 42 checks the value of an interruption flag. The interruption flag indicates whether the processing of the program is temporarily stopped or being executed. In the present embodiment, in a case in which the processing of the program is being executed, the CPU 42 sets a first value in the interruption flag. In a case in which the processing of the program is temporarily stopped, the CPU 42 sets a second value in the interruption flag. For example, the first value is 1, and the second value is 0. The interruption flag is stored in RAM 44.

In a case in which the interruption flag is 1, the CPU 42 temporarily stops the program in operation, and then clears the interruption flag to 0. In a case in which the interruption flag is 0, the CPU 42 releases the temporary stop of the stopped program, and then sets the interruption flag to 1. The CPU 42 exits the interruption processing after setting the interruption flag to 1 or clearing the interruption flag to 0. That is, the CPU 42 executes the interruption processing if the operation section 2 is operated “ON” when the pre-determined program is in operation or in temporary stop. In the present embodiment, an instant-off function is disabled.

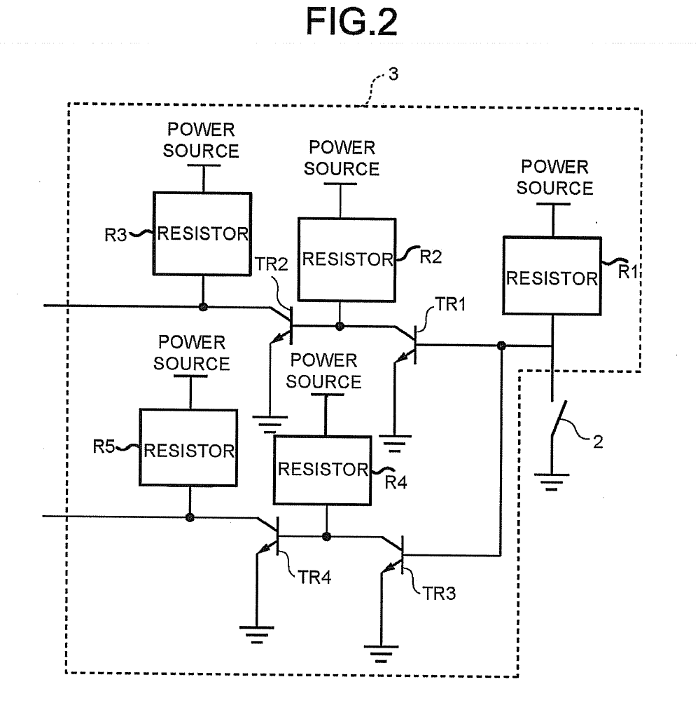

FIG. 2 is a block diagram illustrating an example of the constitution of the signal generation section 3 according to the present embodiment. The signal generation section 3 includes resistors R1˜R5 and transistors TR1˜TR4.

One end of the resistor R1 is connected with the power source, and the other end is connected with the operation section 2. The base of the transistor TR1 is connected with the other end of the resistor R1. The emitter of the transistor TR1 is connected with reference potential. The collector of the transistor TR1 is connected with the other end of the resistor R2 and the base of the transistor TR2. One end of the resistor R2 is connected with the power source. The emitter of the transistor TR2 is connected with reference potential. The collector of the transistor TR2 is connected with the other end of the resistor R3 and the first input section 421 of the control section 4. One end of the resistor R3 is connected with the power source.

The base of the transistor TR3 is connected with the other end of the resistor R1. The emitter of the transistor TR3 is connected with reference potential. The collector of the transistor TR3 is connected with the other end of the resistor R4 and the base of the TR4. One end of the resistor R4 is connected with power source. The emitter of the transistor TR4 is connected with reference potential. The collector of the transistor TR4 is connected with the other end of the resistor R5 and the second input section 422 of the control section 4. One end of the resistor R5 is connected with power source.

In a case in which the operation section 2 is not operated “ON”, high level signal is supplied to the bases of the transistor TR3 and the transistor TR1. Thus, the transistor TR1 and the transistor TR3 are turned into “ON” state. When the transistor TR1 and the transistor TR3 are in the “ON” state, the bases of the transistor TR2 and the transistor TR4 are of low level. Thus, the transistor TR2 is in “OFF” state, and as a result, the first control signal of the first level (high level) is input to the first input section 421. Further, as the transistor TR4 is in “OFF” state, the second control signal of the first level (high level) is input to the second input section 422.

In a case in which the operation section 2 is operated “ON”, low level signal is supplied to the bases of the transistor TR3 and the transistor TR1. Thus, the transistor TR1 and the transistor TR3 are turned into “OFF” state. When the transistor TR1 and the transistor TR3 are in the “OFF” state, the bases of the transistor TR2 and the transistor TR4 are of high level. Thus, the transistor TR2 is in “ON” state, and as a result, the first control signal of the second level (low level) is input to the first input section 421. Further, as the transistor TR4 is in “ON” state, the second control signal of the second level (low level) is input to the second input section 422.

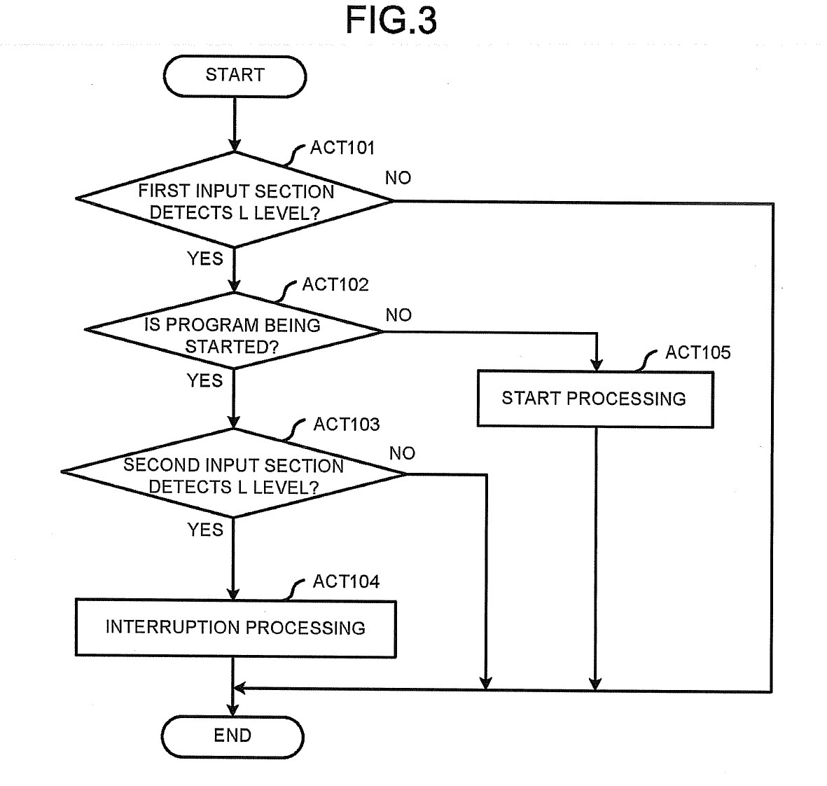

Next, the operation of the control section 4 in a case in which the operation section 2 is operated “ON” is described with reference to the accompanying drawings. FIG. 3 is a flowchart illustrating the operation of the control section 4 in a case in which the operation section 2 is operated “ON”. Incidentally, the operation section 2 is described as a power switch in ₜhe following description. For example, when the user presses the power switch, the first control signal of low level is supplied to the first input section 421. Further, the second control signal of low level is supplied to the second input section 422.

The CPU 42 determines whether or not the first control signal of low level is detected by the first input section 421 (ACT 101). In a case in which the first control signal of low level is detected by the first input section 421 (YES in ACT 101), the CPU 42 determines whether or not the program is being started (ACT 102). In a case in which the first control signal of low level is not detected by the first input section 421 (NO in ACT 101), the CPU 42 does not execute the interruption processing or the start processing.

In a case in which the program is being started (YES in ACT 102), the CPU 42 determines whether or not the second control signal of low level is detected by the second input section 422 (ACT 103). In a case in which the program is not being started (NO in ACT 102), the CPU 42 executes the start processing of the program (ACT 105).

In a case in which the second control signal of low level is detected by the second input section 422 (YES in ACT 103), the CPU 42 executes the interruption processing (ACT 104). In a case in which the second control signal of low level is not detected by the second input section 422 (NO in ACT 103), the CPU 42 does not execute the interruption processing.

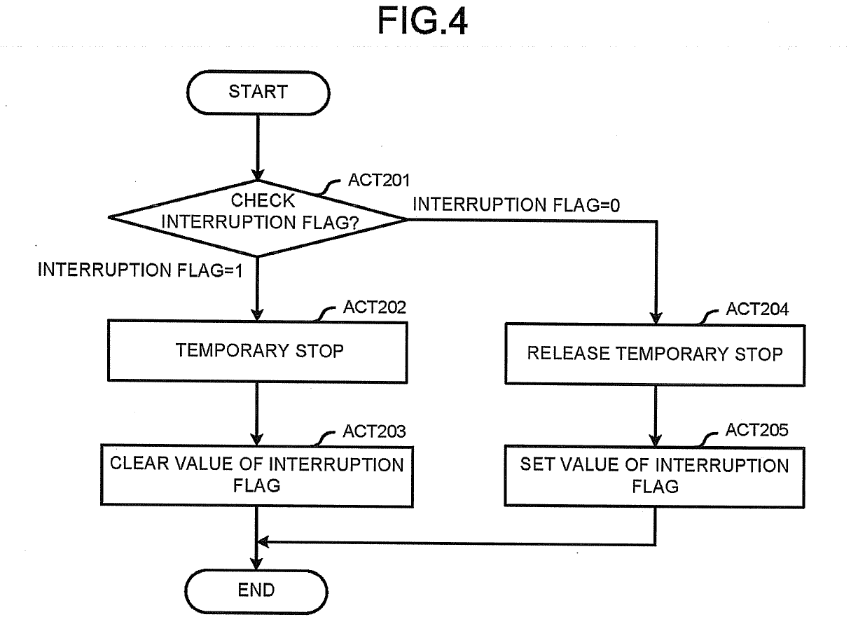

Next, the interruption processing of the control section 4 is described with reference to the accompanying drawings. FIG. 4 is a flowchart illustrating the operation of the interruption processing of the control section 4. Incidentally, as an initial condition, the value of the interruption flag is set to “1”.

The CPU 42 checks the value of the interruption flag (ACT 201). In a case in which the value of the interruption flag is 1, the CPU 42 temporarily stops the program that is being started (ACT 202). Then the CPU 42 clears the value of the interruption flag to 0, and then terminates the interruption processing (ACT 203). In a case in which the value of the interruption flag is 0, the CPU 42 releases the temporary stop of the program in temporary stop (ACT 204). Then the CPU 42 sets the value of the interruption flag to 1, and then terminates the interruption processing.

### A Second Embodiment

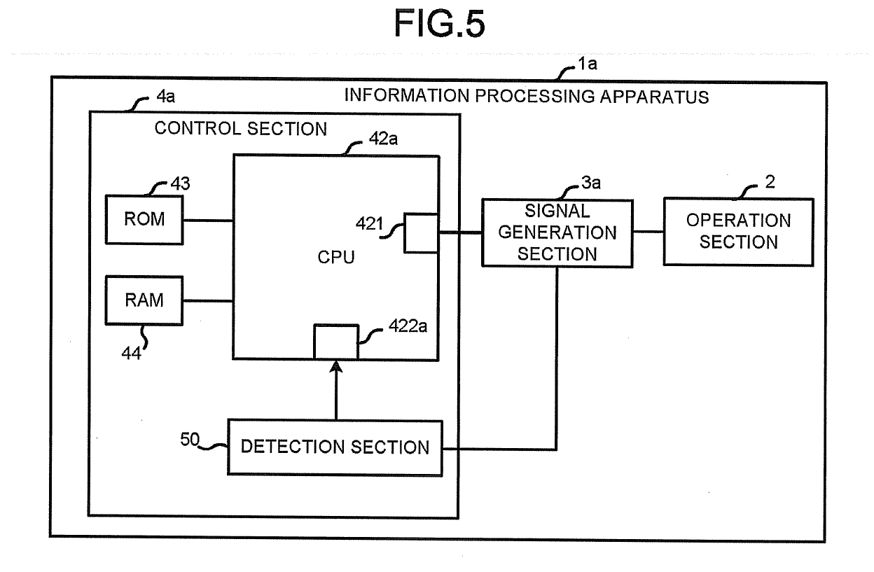

Hereinafter, an information processing apparatus 1a according to the second embodiment is described in detail with reference to the accompanying drawings. FIG. 5 is a diagram illustrating an example of the constitution of the information processing apparatus 1a according to the second embodiment. The information processing apparatus 1a according to the second embodiment further comprises a detection section 50 compared with the information processing apparatus 1 described in the first embodiment. Further, in the second embodiment, the same components as those described in the first embodiment are indicated by the same reference numerals and repetitive description is not provided.

For example, the information processing apparatus 1a is a POS terminal apparatus. The information processing apparatus 1a includes the operation section 2, a signal generation section 3a and a control section 4a.

The signal generation section 3a generates a first control signal and a second control signal based on the operation signal from the operation section 2. The signal generation section 3a, if acquiring the operation signal, generates the first control signal and the second control signal of a first level. The signal generation section 3a, if acquiring no operation signal, generates the first control signal and the second control signal of a second level. The signal generation section 3a outputs the generated first control signal to the control section 4a. The signal generation section 3a outputs each of the generated first control signal and the second control signal to the control section 4a. Incidentally, the first level is a high level, and the second level is a low level.

The control section 4a includes a CPU 42a, the ROM 43, the RAM 44 and the detection section 50. The CPU 42a controls the whole operations of the information processing apparatus 1a through interconnection with the ROM 43 and the RAM 44. The CPU 42a includes the first input section 421 and a second input section 422a. The second input section 422a is connected with the signal generation section 3a. The second input section 422a is a general purpose input/output interface the functions of which can be defined by BIOS. For example, the second input section 422a is defined as an input interface. A detection signal is supplied to the second input section 422a from the detection section 50.

The CPU 42a executes start processing of a pre-determined program if the first input section 421 detects the control signal of low level. That is, the CPU 42a reads the pre-determined program stored in the ROM 43 and copies or decompresses the pre-determined program on the RAM 44. The CPU 42a controls the operation of each section of the information processing apparatus 1a according to the program. For example, the pre-determined program is BIOS. The BIOS is a program in which a routine for controlling the hardware in the system is organized.

If the second input section 422a detects the control signal of low level when the pre-determined program is started, the CPU 42a executes an interruption processing. The interruption processing means temporarily stopping the program in operation or releasing the temporary stop of the program that is in temporary stop. For example, the CPU 42a checks the value of an interruption flag. In a case in which the interruption flag is 1, the CPU 42a temporarily stops the program in operation, and then clears the interruption flag to 0. In a case in which the interruption flag is 0, the CPU 42a releases the temporary stop of the stopped program, and then sets the interruption flag to 1. The CPU 42a exits the interruption processing after setting the interruption flag to 1 or clearing the interruption flag to 0. That is, the CPU 42a executes the interruption processing if the operation section 2 is operated “ON” when the pre-determined program is in operation or in temporary stop. In the present embodiment, an instant-off function is disabled.

The detection section 50, if detecting the control signal of low level from the signal generation section 3a, generates a detection signal of the first level. The detection section 50, if detecting no control signal of low level from the signal generation section 3a, generates a detection signal of the second level. The detection section 50 outputs the detection signal to the second input section 422a.

The operation and the interruption processing of the control section 4a in a case in which the operation section 2 is operated “ON” are the same as those described in the first embodiment, and therefore, repetitive description is not provided.

In accordance with at least one embodiment described above, the information processing apparatus is provided with the operation section, the signal generation section and the control section. The operation section outputs an operation signal indicating that it is operated by a user. The signal generation section generates the first control signal and the second control signal based on the operation signal from the operation section. The control section starts a pre-determined program based on the first control signal and executes an interruption processing of the program based on the second control signal. The interruption processing means temporarily stopping the program being executed or releasing the temporary stop of the program. In this way, it is possible to temporarily stop the processing of the program being executed by the information processing apparatus merely, no matter whether or not a keyboard is connected.

In the embodiment described above, the first level is described as a high level; however, the first level may be a low level. Further, the second level is described as a low level; however, it may be a high level.

In the embodiment described above, the first control signal and the second control signal generated by the signal generation section may be control signals of different levels. For example, the signal generation section, if acquiring the operation signal, may generate the first control signal of the first level and the second control signal of the second level.

In the embodiment described above, in a case in which the information processing apparatus is a POS terminal apparatus, the information processing apparatus further includes an input section, an arithmetic section, a display section and a printer.

The input section inputs the price and the category of a sold commodity. The arithmetic section calculates the total amount of the input commodities. The display section displays the name of the sold commodity, the commodity price and the total amount. The printer prints the commodity name, the commodity price and the total amount displayed on the display screen of the display section.

All or part of the functions of the control section may be realized by the CPU 42 which executes programs that are used for realizing these functions and are recorded in a computer-readable recording medium.

The “computer-readable recording medium” refers to a portable medium and a storage section. For example, the portable medium may be a flexible disk, a magnetic optical disk, a ROM and a CD-ROM. For example, the storage section may be a hard disk drive inside a computer system. Further, the “computer-readable recording medium” may be a network, a device which dynamically holds a program in a short period of time, and a device which holds a program for a certain time. For example, the network is an internet. For example, the device which dynamically holds a program may be a communication line in a case of sending the program through a communication line. For example, the device which holds a program for a certain time may be an inner volatile memory of a computer system serving as a server or a client. Further, the program mentioned above may be used for realizing part of the functions. Moreover, the functions may be realized by combination with the program which is already stored in the computer system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing apparatus comprising:
an operation section configured to output an operation signal indicating that it is operated by a user;
a signal generation section configured to generate a first control signal and a second control signal based on the operation signal from the operation section; and
a control section configured to start a pre-determined program based on the first control signal and execute an interruption processing of the pre-determined program based on the second control signal; wherein
the interruption processing means temporarily stopping the pre-determined program being executed or releasing the temporary stop of the pre-determined program.

2. The information processing apparatus according to claim 1, wherein
the control section executes the interruption processing in a case in which the first control signal or the second control signal is supplied and the pre-determined program is being executed.

3. The information processing apparatus according to claim 1, wherein
the control section includes a first input section to which the first control signal is supplied and a second input section to which the second control signal is supplied.

4. The information processing apparatus according to claim 1, wherein
the control section starts the pre-determined program in a case in which the first control signal or the second control signal is supplied and the pre-determined program is not started.

5. The information processing apparatus according to claim 1, further comprising:
a storage section configured to store an interruption flag in which either a first value indicating that the pre-determined program is being executed or a second value indicating that the pre-determined program is in temporary stop is set.

6. The information processing apparatus according to claim 5, wherein
the control section temporarily stops the processing of the pre-determined program in a case in which the second control signal is supplied and the value of the interruption flag is the first value.

7. The information processing apparatus according to claim 5, wherein
the control section releases the temporary stop of the processing of the pre-determined program in a case in which the second control signal is supplied and the value of the interruption flag is the second value.

8. The information processing apparatus according to claim 5, wherein
the control section sets the interruption flag to the second value after temporarily stopping the pre-determined program, and sets the interruption flag to the first value after releasing the temporary stop.

9. A POS terminal apparatus comprising:
a display section configured to display information;
a printer configured to print the information;
an operation section configured to output an operation signal indicating that it is operated by a user;
a signal generation section configured to generate a first control signal and a second control signal based on the operation signal from the operation section; and
a control section configured to start a pre-determined program based on the first control signal and execute an interruption processing of the pre-determined program based on the second control signal; wherein
the interruption processing means temporarily stopping the pre-determined program being executed or releasing the temporary stop of the pre-determined program.

10. A computer-readable non-temporary recording medium for recording a program which enables a computer to execute the following processing:
outputting an operation signal indicating that it is operated by a user;
generating a first control signal and a second control signal based on the operation signal from the operation section; and
starting a pre-determined program based on the first control signal, and temporarily stopping the pre-determined program being executed or releasing the temporary stop of the pre-determined program based on the second control signal.
